(19) United States
(12) Patent Application Publication
(10) Pub. No.: US 2007/0081825 A1
(43) Pub. Date: Apr. 12, 2007

(54) MULTIMODE DISTANCE EXTENSION

(76) Inventors: Damiano Rossetti, Milano (IT); Gilberto Loprieno, Milano (IT)

Correspondence Address: AKA CHAN LLP / CISCO, 900 LAFAYETTE STREET, SUITE 710, SANTA CLARA, CA, 95050, US

(21) Appl. No.: 11/163,144

(22) Filed: Oct. 6, 2005

(51) Int. Cl. H04B 10/12

(52) U.S. Cl. 398/141

(57) ABSTRACT

Methods and apparatus for increasing the operational distance of multimode fibers are disclosed. According to one aspect of the present invention, an optical transmitter includes a framer that frames data and a scrambler that scrambles the data after the data is framed. The optical transmitter also includes an encoder that applies a forward error correction algorithm to encode the data after the data is scrambled, as well as a source that transmits the data across the multimode fiber after the data is encoded.

### BACKGROUND OF THE INVENTION

1. Field of Invention

The present invention relates generally to allowing multimode fibers to support relatively high bit rates. More specifically, the present invention relates to providing forward error correction (FEC) coding in networks that utilize multimode fibers such that the operational distance of the multimode fibers may be increased when data is transmitted at relatively high bit rates.

2. Description of the Related Art

The use of networks such as local area networks is becoming increasingly prevalent, and the rates at which data may be streamed has been increasing dramatically. For example, approximately 10 Gigabit (G) Ethernet rates for the streaming of data are becoming more prevalent. Many older local area networks were created using multimode fibers and, as a result, were intended to support traffic at relatively low data rates. As a result, the local area networks that were created using multimode fibers often suffer degraded performance when supporting higher data rates in that the maximum distance over which traffic at relatively high data rates may pass is limited.

Local area networks are generally included in wide area networks. FIG. 1 is a diagrammatic representation of an overall wide area network which includes a local area network with multimode fibers. A wide area network 106, as for example the Internet or the World Wide Web, includes any number of local area networks 102a, 102b. In many instances, a local area network such as local area network 102a includes multimode fibers 110a-d or, more specifically, multimode optical fibers 110a-d, which allow communication between nodes 104a-d. A node such as node 104a of local area network 102a may be in communication with a node 104e that is part of another local area network 104e over a fiber 114. Fiber 114 may be a multimode fiber or a long haul fiber.

Nodes 104a-d may include optical transmitters and receivers that effectively enable multimode fibers 110a-d to support optical traffic at either 850 nanometers (nm) or 1310 nm. In other words, optical transmitters associated with nodes 104a-d may include either light emitting diodes with an operational wavelength of 850 nm or light emitting diodes with an operational wavelength of 1210 nm. However, multimode fibers 110a-d typically are unable to support data streams of approximately 10 G over distances of approximately 40 meters (m). That is, traffic at 10 G Ethernet rates often may not be supported by local area network 102a.

Within a multimode fiber, light that is provided into the fiber by a transceiver or a light source such as a light emitting diode travels the length of the fiber in multiple paths or modes, each of which has a different angle of reflection within a core of the multimode fiber. The propagation of light through a multimode fiber in multiple paths generally limits the bandwidth and maximum distance that may be supported by the multimode fiber, as the multiple paths generally disperse over longer lengths, i.e., multimode fibers are subject to modal dispersion. Hence, multimode fibers are generally used as data communications links for relatively short distances, e.g., within a local area network.

FIG. 2 is a cross-sectional side-view representation of a multimode fiber in which light is traveling in multiple paths between an optical transmitter and a receiver. An optical transmitter 200 emits light, as for example from a light emitting diode, in pulses. The light emitting diode of optical transmitter 200 typically operates at a wavelength of either 850 nm or 1310 nm, as previously mentioned. The emitted light travels across a multimode fiber 206 or, more specifically, within a core 212 of multimode fiber 206 which also includes a cladding 208. The light travels in multiple waves or modes 216a-c which reach a detector 204 at different times, which causes the bandwidth that may be accommodated by multimode fiber 206 to be substantially limited. As will be appreciated by those skilled in the art, multimode fiber 206 may be associated with hundreds of modes, though only modes 216a-c are shown for ease of illustration.

With reference to FIG. 3, an optical transmitter and a receiver which are in communication over a multimode fiber will be described. An optical transmitter 302 includes a framer 318 that is arranged to organize input data 314, e.g., data that is provided to optical transmitter 302, into frames. Optical transmitter 302 also includes a scrambler 322 to scrambles the data contained within the frames to substantially randomize the data. Scrambled, framed data is transported from optical transmitter 302 to a receiver 306 using a multimode fiber 310. A descrambler 330 of receiver 306 descrambles the received data, and a deframer 326 of receiver 306 deframes the data. Once the data received across multimode fiber 310 is descrambled and deframed, the descrambled and deframed data 314′ is provided by receiver 306 to an intended destination. The destination may be a computing system that is in communication with receiver 306.

Multimode fibers typically are unable to support communications at an approximately 10 G rate over operational distances that exceed approximately 40 m without significant degradation. An optical transmitter associated with a multimode fiber typically includes either a light emitting diode operating at a wavelength of 850 nm or a light emitting diode operating at a wavelength of 1310 nm. For an optical transmitter that includes an 850 nm light emitting diode, the maximum link span over which data may be sent at a 10 G rate is approximately equal to twenty six meters with a modal bandwidth of approximately 160 MegaHertz kilometers (MHz-km).

For optical transmitters with 1310 nm light emitting diodes, some implementations may allow the an increase in the maximum link distance over which data at a 10 G rate may be sent. When an optical transmitter includes a 1310 nm light emitting diode, an LX4 standard may be used to increase the maximum link distance over which data at a 10 G rate may effectively be sent. To enable a longer distance to be reached, rather than using a single 10 G data stream, the LX4 standard uses four data streams at a lower bit rate. While the use of four data streams at a lower bit rate is effective in allowing the operational distances for multimode fibers to be increased, the use of four data streams requires four optical transmitters and four receivers. The implementation of four optical transmitters and four receivers is often expensive, inefficient, and impractical.

Another method which has been used to improve the maximum link distance associated with multimode fibers and a 1310 nm light emitting diode involves the implementation of an electronic dispersion compensator (EDC). An EDC is arranged to substantially mitigate the effects of dispersion electronically before an optical signal is detected by a photodetector, as phase information is typically lost when the optical signal is detected by the photodetector. While an EDC is generally effective in “cleaning” a signal received across a multimode fiber, the reliablity of EDCs is unpredicatable. As a result, an EDC may not necessarily always increase the maximum link distance associated with a multimode fiber.

Therefore, what is needed is a method and an apparatus which enables the operational distance of a multimode fiber to be increased when the multimode fiber supports approximately 10 G data rates. That is, what is desired is a system which enables the operational distance of a multimode fiber that supports approximately 10 G data rates to be efficiently and reliably increased.

### BRIEF DESCRIPTION OF THE DRAWINGS

The invention may best be understood by reference to the following description taken in conjunction with the accompanying drawings in which:

FIG. 1 is a diagrammatic representation of a wide area network which includes a local area network that utilizes multimode fibers.

FIG. 2 is a diagrammatic cross-sectional representation of a signal being sent across a multimode fiber.

FIG. 3 is a block diagram representation of an optical transmitter and a receiver that are used to allow optical communications across a multimode fiber.

FIG. 4A is a block diagram representation of an optical transmitter that includes a forward error correction (FEC) encoder and a receiver that includes a FEC decoder and is in communication with the optical transmitter across a multimode fiber in accordance with an embodiment of the present invention.

FIG. 4B is a block diagram representation of an optical transmitter that includes a FEC encoder and an interleaver, as well as a receiver that is in communication with the optical transmitter across a multimode fiber and includes a FEC decoder as well as a deinterleaver in accordance with an embodiment of the present invention.

FIG. 5 is a diagrammatic representation of a system in which bits which are processed by an FEC encoder are interleaved in accordance with an embodiment of the present invention.

FIG. 6A is a diagrammatic representation of a frame that includes FEC bytes and is divided into four rows.

FIG. 6B is a diagrammatic representation of sub-rows of a row of a frame that includes FEC bytes.

FIG. 7 is a process flow diagram which illustrates one method of providing FEC for data that is to be transmitted across a multimode fiber in accordance with an embodiment of the present invention.

FIG. 8 is a process flow diagram which illustrates one method of receiving and processing data that has been encoded using FEC and sent over a multimode fiber in accordance with an embodiment of the present invention.

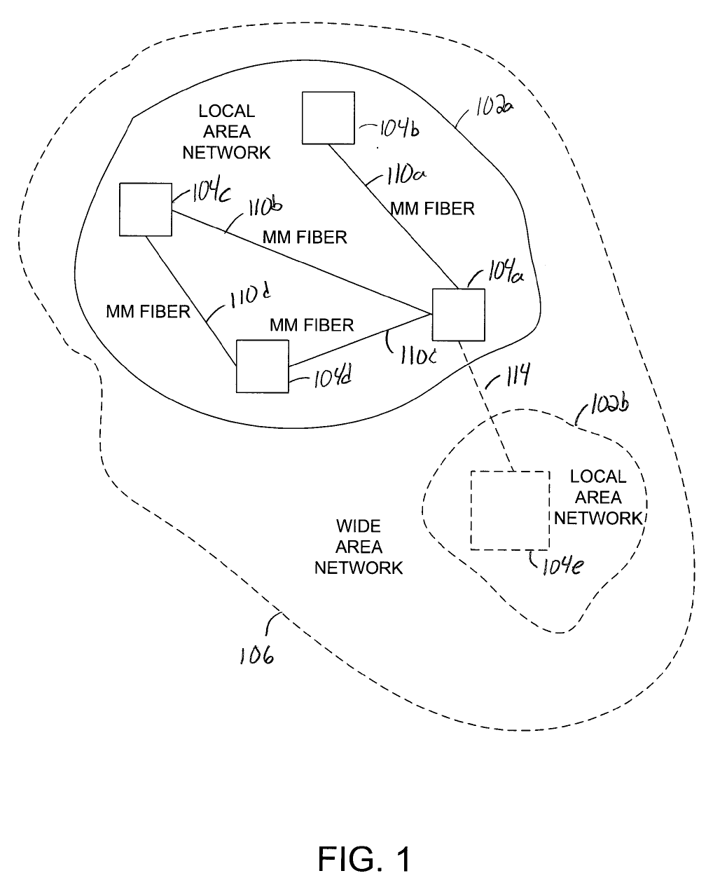

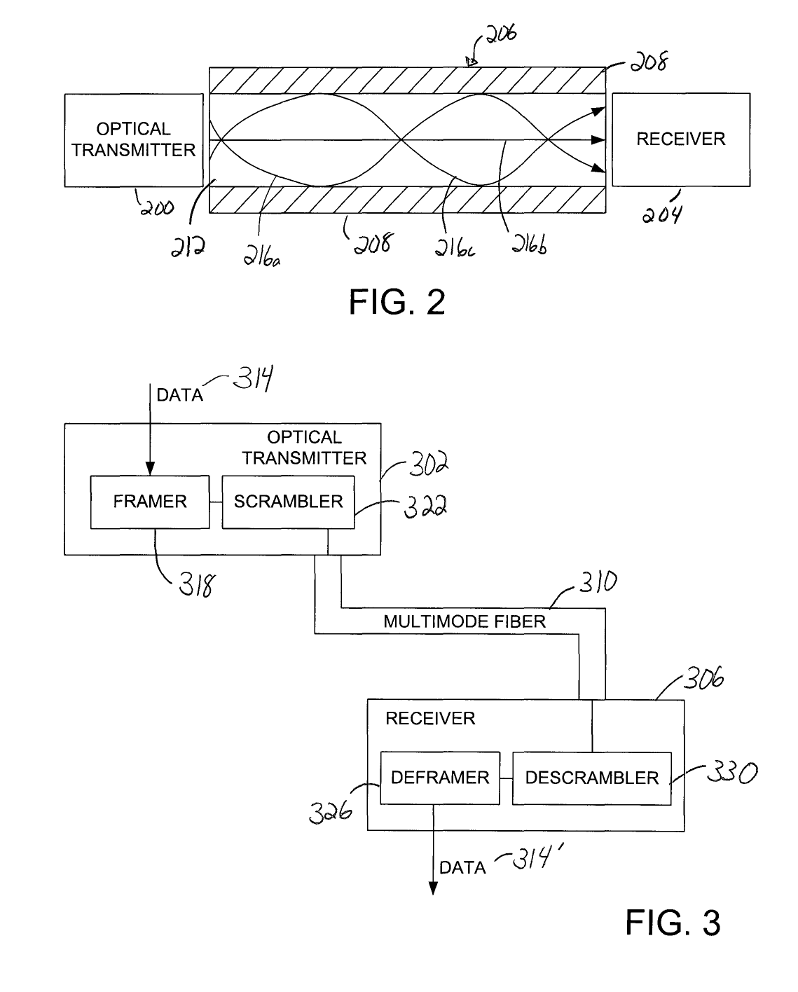

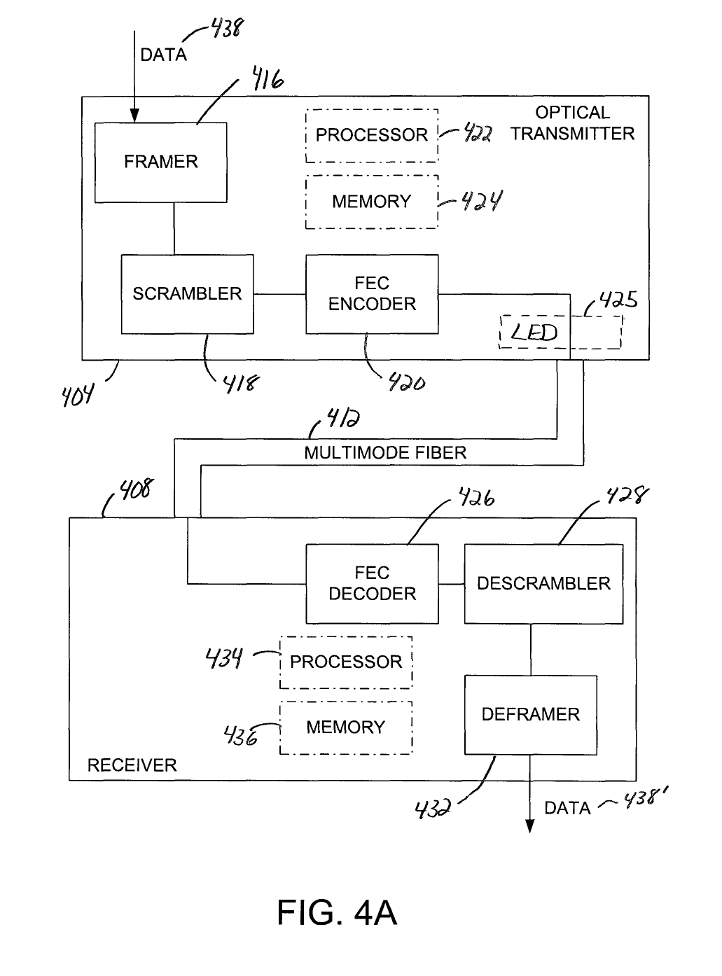

### DETAILED DESCRIPTION OF THE EMBODIMENTS

With many local area networks being in communication across multimode fibers, there is a need for efficient and reliable methods that allow the operational distances of the multimode fibers to be increased when approximately 10 Gigabit (G) data rates are supported. Implementing forward error correction (FEC) with respect to data that is to be transmitted across a multimode fiber enables distances over which the data may be transmitted to be increased by allowing errors, as for example errors due to degradation, to be substantially corrected by a receiver. FEC is a system of error control that allows a receiver to detect and to correct up to a predetermined number or fraction of bits or symbols that are corrupted by transmission errors. As will be appreciated by those skilled in the art, FEC is accomplished by adding redundancy to data that is transmitted. Such redundancy may generally be added using a predetermined algorithm. The redundancies may be in the form of bits that are a function of multiple information bits included in the original data.

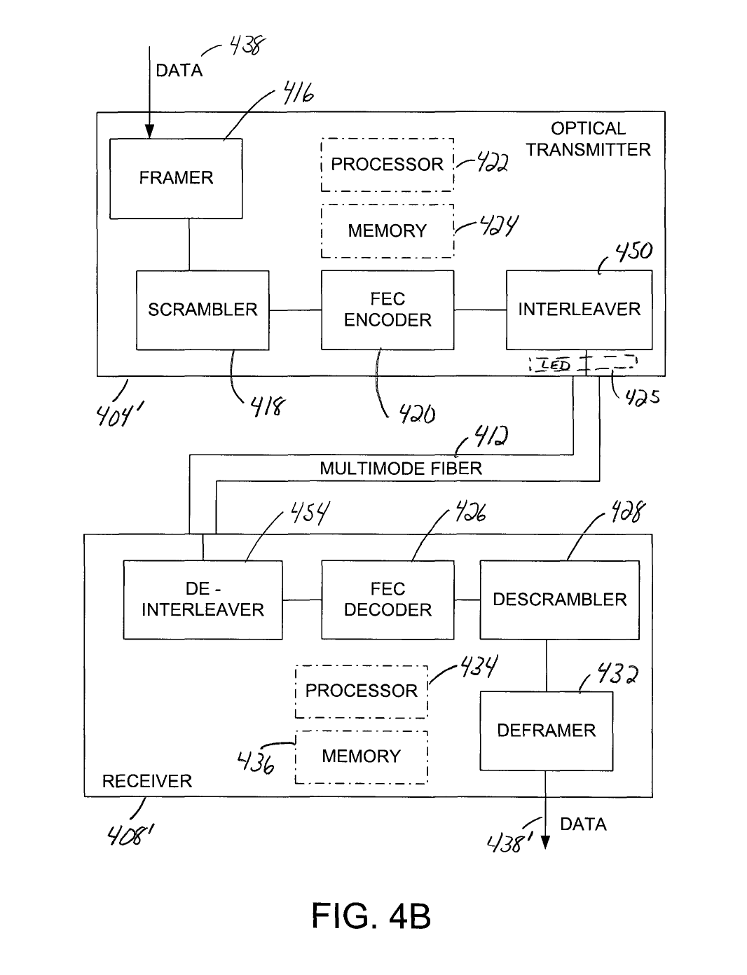

By encoding data using an FEC algorithm prior to transmitting the data over a multimode fiber, a receiver that receives the data may be able to correct errors caused by degradation. With reference to FIG. 4A, an optical transmitter and a receiver which are in communication across a multimode fiber and are arranged to support FEC encoded data will be described in accordance with an embodiment of the present invention. An optical transmitter 404 that is in communication with a receiver 408 across a multimode fiber 412 is arranged to receive input data 438. Input data 438 may generally be received from a computing system that is in communication with optical transmitter 404, or from a component of an overall computing system of which optical transmitter 404 is also a part.

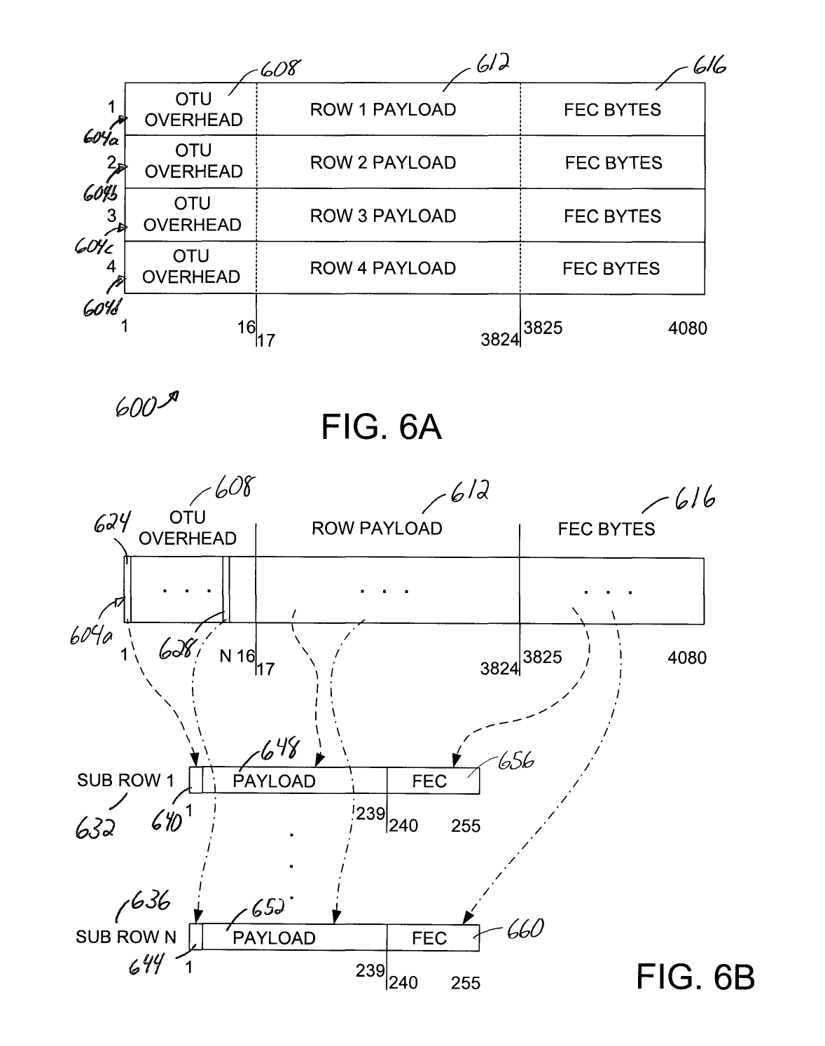

Input data 438 is provided as a stream to a framer 416 that frames input data 438. Once framed by framer 416, the data is scrambled by scrambler 418 to randomize the data. The scrambled data is then provided to an FEC encoder 420 that effectively provides error control within the data. FEC encoder 420 adds redundancy to the data by adding check bits to the data. FEC encoder 420 may generally use any suitable algorithm to add error control functionality to the data. In one embodiment, FEC encoder 420 uses a Reed-Solomon code such as RS(255,239), as specified in the ITU-T G. 709 “Interface for the Optical Transport Network (OTN)” standard, which is incorporated herein by reference in its entirety. The RS(255,239) Reed-Solomon code generally specifies that 239 bytes of a frame may be used as information bytes to calculate an FEC parity check of sixteen bytes, namely byte 239 through byte 255 of the frame. A frame which includes FEC parity check bytes will be described below with respect to FIGS. 6A and 6B. Up to approximately sixteen incorrect symbols may be detected out, and up to approximately eight incorrect symbols out of approximately 255 symbols may be corrected using the RS(255,239) Reed-Solomon code.

Framer 416, scrambler 418, and FEC encoder 420 may be arranged to cooperate with a processor 422 and a memory 424. For example, memory 424 may include a buffer that stores data 438 at least temporarily, while processor 422 may execute program codes or code devices which allow FEC encoder 420 to implement error control functionality. Such program codes or code devices may be programmed onto an application specific integrated circuit or embodied on a computer program product, in some embodiments. Memory 424 may further be used to store program codes associated with optical transmitter 404.

From FEC encoder 420, data passes through multimode fiber 412 as light emitted from a source 425. Multimode fiber 412 may be coupled to optical transmitter 404 through a port or an interface between multimode fiber 412 and source 425. Source 425 may be a light emitting diode or any suitable device which is capable of emitting light that contains the data. Receiver 408 is arranged to receive data over multimode fiber 412, and an FEC decoder 426 of receiver 408 is arranged to substantially decode the received data. Multimode fiber 412 may be coupled to receiver 408 through a port or an interface. FEC decoder 426 generally detects errors such as degradation errors that arise during transmission over multimode fiber 412. When FEC decoder 426 is associated with a RS(255,239) Reed-Solomon code, FEC decoder 426 detects up to approximately sixteen incorrect symbols and may correct up to approximately eight incorrect symbols.

As will be understood by those skilled in the art, Reed-Solomon codes are typically specified with a total number of symbols per codeword, and a number of information symbols. Hence, for a Reed-Solomon code specified as RS(255,239), there are approximately 255 total symbols, approximately 239 information symbols, and approximately 16 check symbols. Reed-Solomon codes allow one error symbol to be detected and corrected for every two check symbols.

In one embodiment, as FEC encoder 420 performs encoding such that optical transmitter 404 effectively sends characters originally included in input data 438 twice in a frame sent across multimode fiber 412. That is, FEC encoder 420 sends redundant data. FEC decoder 426 checks both instances of each received character to determine whether either character adheres to an appropriate protocol. In other words, FEC decoder 426 substantially understands the redundancy added by FEC encoder 420 and is able to determine if a transmission error has occurred. For example, when one instance of a received character conforms to the appropriate protocol while the other instance of the received character does not, the character that conforms to the protocol is accepted as being correct.

Once FEC decoder 426 decodes data and corrects errors as appropriate, the decoded data is provided to descrambler 428 which descrambles the data, and provides the data to a deframer 432 that deframes the data. Deframed data 438′ may then be provided by receiver 408 to an appropriate destination. The appropriate destination may be, for example, another part of an overall computing system that includes receiver 408, or a computing system that is separate from receiver 408 but in communication with receiver 408.

To further enhance the performance of a system in which frames with FEC encoding are sent across a multimode fiber, interleaving and deinterleaving capabilities may be provided to an optical transmitter and to a receiver, respectively. An interleaver, e.g., a convolutional interleaver, rearranges a sequence of bits or symbols in a substantially deterministic manner, while a deinterleaver substantially restores the rearranged sequence of bits into an original sequence. Interleaving may generally occur at any suitable depth, as will be understood by those skilled in the art. Providing interleaving to FEC encoded frames allows any errors in the frames to be dispersed more randomly, thereby allowing for more efficient error recovery. That is, the effect of burst errors that occur in consecutive bits may be shared across multiple codewords when data associated with the codewords is interleaved.

With reference to FIG. 4B, an optical transmitter that includes an interleaver and is in communication with a receiver that includes a deinteleaver will be described in accordance with an embodiment of the present invention. An optical transmitter 404′, like optical transmitter 404 of FIG. 4A, is arranged to receive a stream of input data 438 and to process data 438 using framer 416, scrambler 418, and FEC encoder 420. Once FEC encoder 420 provides error correction information to frames which contain the data, the data is provided to an interleaver 450 which interleaves the bits in the frames. The interleaved data is then provided as information in light pulses emitted by source 425 onto multimode fiber 412.

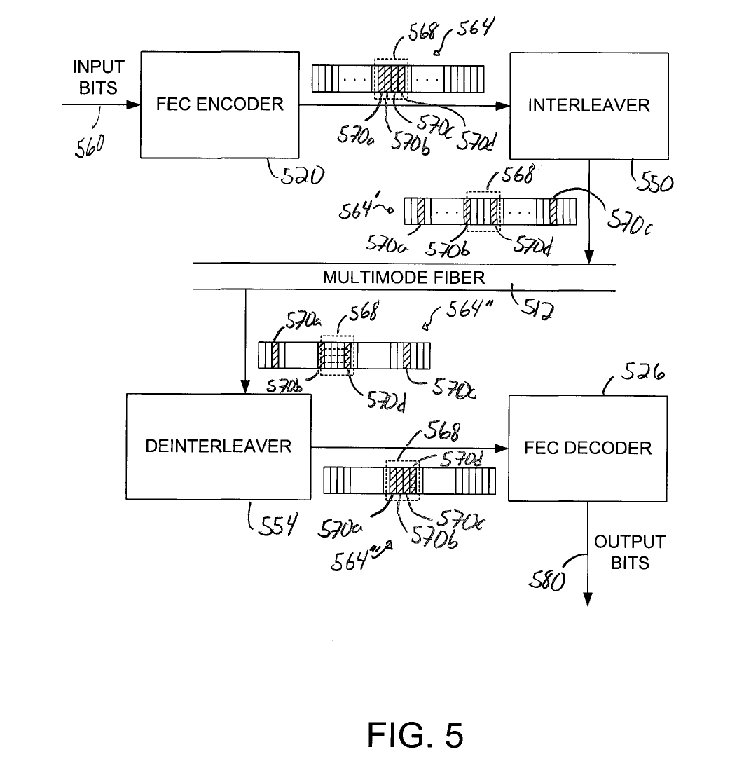

When a receiver 408′ receives the interleaved data, a deinterleaver 454 deinterleaves the received data. As transmission errors are such that incorrect bits or symbols are relatively close together within a data stream or frame, the use of interleaver 450 allows the incorrect bits to effectively be spread out once the data stream or frame is deinterleaved. By way of example, in the system of FIG. 4A, incorrect bits may be consecutive bits when data is received by FEC decoder 426. Consecutive bits may be relatively difficult to detect. When interleaver 450 is used, incorrect bits in an interleaved stream may be consecutive, but the incorrect bits are not consecutive once the bits are deinterleaved by deinterleaver 450 into their original sequence. Hence, the incorrect bits are dispersed and easier to detect. The functionality of an interleaver will be described below with respect to FIG. 5. Once deinterleaver 454 deinterleaves received data, the deinterleaved data provided to FEC decoder 426, descrambler 428, and deframer 432. The resulting output data 438′ may then be forwarded to an intended destination.

Referring next to FIG. 5, the use of an interleaver and a deinteleaver to enable errors to be dispersed in a data stream will be described in accordance with an embodiment of the present invention. Input bits 560 are provided to an encoder 520, as for example via a scrambler, that encodes the input bits into bytes 564 that includes byte locations 568. Contained within byte locations 568 are bytes 570a-d, which may generally be encoded bytes.

Once bytes 564 are encoded, bytes are interleaved by an interleaver 550 to generate interleaved bytes 564′. Interleaver 550 effectively reorders bytes 564 such that sequential bytes are no longer sequential within interleaved bytes 564′. Within interleaved bytes 564′, bytes 570a-d are interspersed such that bytes 570a-d are no longer consecutive. Of bytes 570a-d, only byte 570d remains within byte locations 568. When bytes 564′ are transmitted or otherwise sent across a multimode fiber 512, errors may occur such that bytes contained within byte locations 568 include errors. When errors occur, the errors typically have an effect on consecutive bytes within a bit stream. For example, bytes 564″, which are received by a deinterleaver 554, are such that bytes included in byte locations 568 have errors. As byte 570d is included in byte locations 568, byte 570d also includes an error.

Deinterleaver 554 is arranged to deinterleave bytes 564″ to generate deinterleaved bytes 564′″. That is, deinterleaver 554 is arranged to reorder bytes 564″ such that the bytes in deinterleaved bytes 564′″ have substantially the same order as bytes 564. Deinterleaving bytes 564″ substantially disperses the errors contained at byte locations 568 of bytes 564″. As shown, when byte locations 568 of bytes 564′″ contain bytes 570a-c, because only byte 570d was included in byte locations 568 of bytes 564″, only byte 570d has an error while bytes 570a-c are substantially error-free. The dispersion of bytes which contain errors improves the likelihood that an FEC decoder 526 may compensate for the errors when FEC decoder 526 processes bytes 564′″ to produce output bytes 580, as isolated errors are typically easier to recognize and to correct than errors which encompass a plurality of sequential bytes. In other words, the dispersion of bytes which contain errors allows FEC decoder 526 to recover more errors than would be recovered if the bytes were not dispersed, e.g., if the bytes were not interleaved prior to transmission across multimode fiber 512.

FIG. 6A is a diagrammatic representation of a frame that is suitable for use in an optical transport network and includes FEC bytes in accordance with an embodiment of the present invention. A frame 600 may be considered to be an optical transport unit (OTU) and generally includes four rows 604a-d. Each row 604a-d includes approximately 4080 bytes. The bytes are effectively grouped into multiple sections. For ease of discussion, the grouping of bytes within row 604a will be described, although it should be appreciated that bytes associated with each row 604a-d are grouped in substantially the same manner.

Within row 604a, overhead bytes 608 generally encompass bytes one through sixteen. Overhead bytes 608 generally are used for carrying communications channels, and for purposes include frame and multiframe alignment. Bytes seventeen through 3824 generally include the payload 612 for row 604a. Typically, payload 612 contains data to be transmitted from a source to a destination. Finally, bytes 3825 through 4080 of row 604a contain FEC bytes 616, e.g., Reed-Solomon check symbols.

Each row 604a-d may be divided into a number of sub-rows, as shown in FIG. 6B. For example, row 604a may be divided into sixteen sub-rows including sub-rows 632, 636 that each include approximately 255 bytes. Overhead bytes 608 include sixteen bytes, and each byte included in overhead bytes 608 is provided to one of the sixteen sub-rows. For ease of illustration, two sub-rows 632, 636 of the sixteen sub-rows are shown. A first byte 624 is generally provided to a first sub-row 632, and an “Nth” byte 628 is provided to a sub-row “N” 636. It should be appreciated that “N” is an integer which has a value in the range between one and sixteen, inclusive.

The data contained in payload 612 is divided between all sixteen sub-rows, and stored into payloads of the sub-rows such as payloads 648, 652 associated with sub-rows 648, 652. Payloads 648, 652 generally each include 238 bytes. FEC bytes 616 are also divided between all sixteen sub-rows. By way of example, approximately sixteen bytes are stored as FEC bytes 656 in sub-row 632 and approximately sixteen bytes are stored as FEC bytes 660 in sub-row 636.

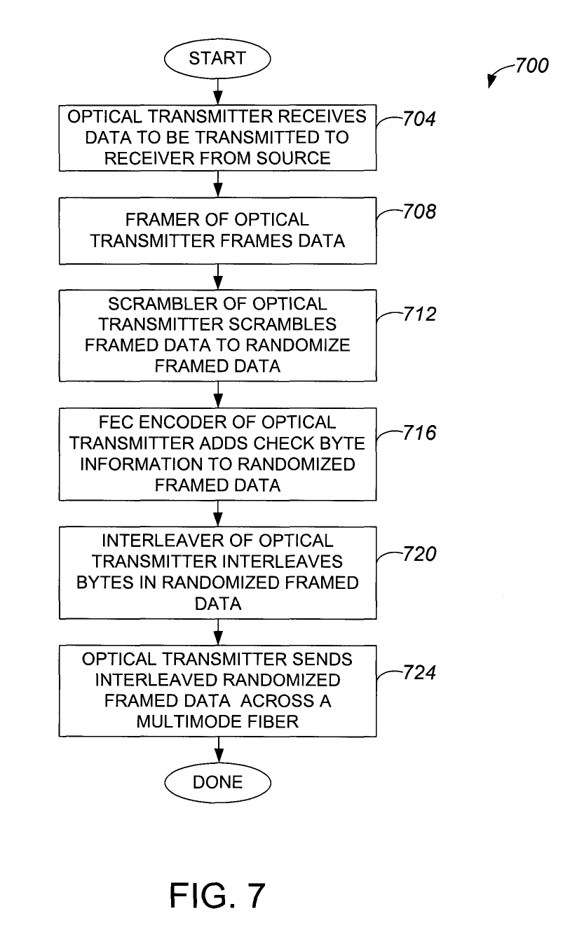

Frame 600 of FIG. 6A or, more specifically, the contents of frame 600 may be interleaved in the course of preparing the frame for transmission across a multimode fiber. FIG. 7 is a process flow diagram which illustrates steps associated with one method of providing FEC for data that is to be transported across a multimode fiber in accordance with an embodiment of the present invention. A process 700 of providing FEC for data begins at step 704 in which an optical transmitter receives data that is to be transmitted to a receiver from a source. The source from which the optical transmitter receives data may be a network element or a computing system that is in communication with the source, or a network element of which the optical transmitter is a component. Once the optical transmitter receives the data to be transmitted, a framer of the optical transmitter frames the data in step 708. The framed data is then scrambled by a scrambler of the optical transmitter in step 712 to randomize the framed data. After the framed data is scrambled or randomized, process flow moves to step 716 in which an FEC encoder of the optical transmitter adds check byte information to the randomized, framed data. As previously mentioned, the FEC encoder may utilize substantially any suitable FEC algorithm. Suitable FEC encoding algorithms include, but are not limited to, algorithms that use Reed-Solomon codes.

In the described embodiment, once check byte information is added to the randomized, framed data, an interleaver of the optical transmitter interleaves the randomized, framed data in step 720. It should be appreciated that the check byte information, which is part of the randomized, framed data, is also interleaved. As discussed above with respect to FIG. 5, interleaving enhances the performance associated with FEC because it generally increases error recovery capabilities. The interleaved data is sent, in step 724, across or otherwise provided to a multimode fiber. After the interleaved data is sent, the process of providing FEC for data that is to be transmitted across a multimode fiber is completed.

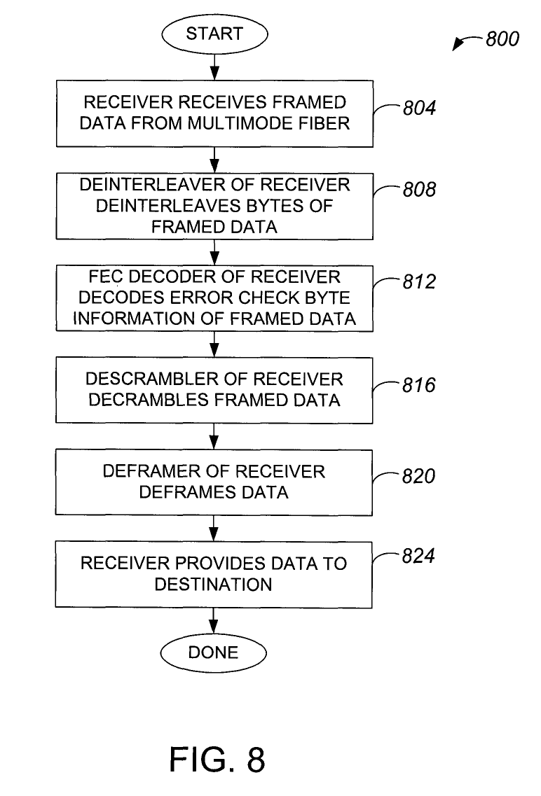

A receiver, e.g., receiver 408′ of FIG. 4B, generally obtains interleaved data off of a multimode fiber. With reference to FIG. 8, one method of processing interleaved data encoded using FEC will be described in accordance with an embodiment of the present invention. A method 800 of processing data encoded using FEC begins at step 804 in which a receiver receives or otherwise obtains the data over a multimode fiber. In the described embodiment, the data is interleaved, randomized, and framed. A deinterleaver of the receiver deinterleaves the data in step 808. Deinterleaving the data generally includes reordering the bytes in the data and effectively reversing the interleaving process used to interleave the data. Once the data is deinterleaved, process flow moves to step 812 in which a FEC decoder of the receiver decodes error check byte information in the data. In other words, the FEC decoder detects and recovers errors. The number of errors that may be detected and the number of errors that may be recovered may vary depending upon the algorithm used to encode the data. By way of example, when the data is encoded using a Reed-Solomon code, up to approximately sixteen symbol or byte errors may be detected in each sub-row of a frame, and up to approximately eight byte errors in each sub-row of a frame may be corrected by the FEC decoder operating using Reed-Solomon decoding.

After the data is decoded in step 812, a descrambler of the receiver descrambles the data in step 816. Once the data is descrambled, a deframer of the receiver deframes the data in step 824. The deframed data is then provided to an intended destination in step 824, and the processing of data encoded using FEC is completed.

For a local area network that is implemented using multimode fibers and supports a bit rate of 10 G, when FEC is added to frames, the actual bit rate may be slightly higher than 10 G. That is, the data rate through multimode fibers is increased as the size of frames transmitted through the multimode fibers is increase. A Q-factor penalty, which affects the Q-factor or the quality of an optical signal, is introduced. The Q-factor penalty may generally be expressed as a function of the ratio of a nominal bit rate to an actual bit rate. While FEC encoding typically introduces a Q-factor penalty, FEC encoding increases the operational distance of multimode fibers significantly, and more than compensates for the Q-factor penalty. It has been observed that for an optical transmitter and receiver operating at approximately 850 nm, the quality of a signal sent without FEC over a multimode fiber that is approximately 40 meters in length is comparable to the quality of a signal sent with FEC over a multimode fiber that is approximately 105 meters in length. That is, a signal sent without FEC over a multimode fiber that is approximately 40 meters in length has approximately the same bit error rate as a signal sent with FEC over a multimode fiber that is approximately 105 meters in length.

Although only a few embodiments of the present invention have been described, it should be understood that the present invention may be embodied in many other specific forms without departing from the spirit or the scope of the present invention. By way of example, although FEC has been described as utilizing a Reed-Solomon code as specified in ITU-T G.709, substantially any suitable algorithm may be used to implement FEC. That is, essentially any suitable algorithm which adds redundant coding to source data to facilitate the accurate reconstruction of the source data by a receiver may be used to provide FEC. Suitable algorithms include, but are not limited to, BCH codes and Reed Muller, and Turbo Codes.

It should be appreciated that a FEC encoder may generally be an encoder arrangement that includes any number of discrete encoders, e.g., any number of discrete Reed-Solomon encoders. The number of discrete Reed-Solomon encoders needed to provide FEC may depend at least in part upon the maximum data rate associated with each Reed-Solomon encoder. Similarly, a FEC decoder may also be a decoder arrangement that includes at least one discrete decoder.

In general, an optical transmitter has been described as being suitable for transmitting data across a multimode fiber, while a receiver has been described as being suitable for receiving or obtaining data that is transmitted across a multimode fiber. In one embodiment, an optical transceiver may be arranged to both transmit and to receive data. That is, an optical transmitter as described above may be an optical transceiver, and a receiver as described above may also be an optical transceiver.

An FEC encoder and an FEC decoder may be implemented using hardware, software such as program code devices embodied on a computer-readable medium, or a combination of hardware and software. Similarly, other components of an optical transmitter and a receiver, as for example an interleaver and a deinterleaver, may also be implemented using hardware, software, or a combination of both.

A deinterleaver of a receiver is typically aware of the type of interleaving used to interleave data received by the receiver. For example, a deinterleaver is generally aware of an interleaving depth value used by an interleaver to interleave data that is provided to the deinterleaver. The knowledge of the interleaving depth, in addition to knowledged of other information associated with the interleaver, enables the deinterleaver to substantially reverse the interleaving process.

The steps associated with the methods of the present invention may vary widely. Steps may be added, removed, altered, and reordered without departing from the spirit of the scope of the present invention. By way of example, steps associated with interleaving the bytes to be transmitted across a multimode fiber and deinterleaving bytes received across the multimode fiber may be removed. Therefore, the present examples are to be considered as illustrative and not restrictive, and the invention is not to be limited to the details given herein, but may be modified within the scope of the appended claims.

What is claimed is:

1. An optical transmitter, the optical transmitter being arranged to send data on a multimode fiber, the optical transmitter comprising:
a framer, the framer being arranged to frame the data;
a scrambler, the scrambler being in communication with the framer and arranged to scramble the data after the data is framed;
an encoder, the encoder being in communication with the scrambler and arranged to apply a forward error correction algorithm to encode the data after the data is scrambled; and
a source, the source being in communication with the encoder and arranged to transmit the data across the multimode fiber after the data is encoded.

2. The optical transmitter of claim 1 wherein the forward error correction algorithm is a Reed-Solomon algorithm.

3. The optical transmitter of claim 1 further including:
an interleaver, the interleaver being in communication with the encoder and with the source, the encoder being in communication with the source through the interleaver, wherein the interleaver is arranged to interleave the data after the data is encoded.

4. A method for processing data at an optical transmitter, the optical transmitter being arranged to transmit the data across a multimode fiber, the method comprising:
obtaining the data;
framing the data;
scrambling the data;
encoding the data, wherein encoding the data includes applying forward error correction to the data; and
transmitting the data across the multimode fiber after the data is encoded.

5. The method of claim 4 wherein transmitting the data further includes:
interleaving the data before transmitting the data across the multimode fiber.

6. An optical transmitter, the optical transmitter being arranged to send data on a multimode fiber, the optical transmitter comprising:
means for obtaining the data;
means for framing the data;
means for scrambling the data;
means for encoding the data, wherein the means for encoding the data include means for applying forward error correction to the data; and
means for transmitting the data across the multimode fiber after the data is encoded.

7. A receiver, the receiver being arranged to process data obtained from a multimode fiber, the receiver comprising:
a decoder, the decoder being arranged to apply a forward error correction decoding algorithm to decode the data obtained from the multimode fiber;
a descrambler, the descrambler being in communication with the decoder and arranged to unscramble the data after the data is decoded; and
a deframer, the deframer being arranged to unframe the data.

8. The receiver of claim 7 further including:
a deinterleaver, the deinterleaver being arranged to deinterleave the data and to provide the data to the decoder after the data is deinterleaved.

9. A method for processing data at a receiver, the receiver being arranged to obtain data from a multimode fiber, the method comprising:
obtaining the data from the multimode fiber;
decoding the data, wherein decoding the data includes applying a forward error correction decoding algorithm to the data;
descrambling the data after the data is decoded; and
deframing the data after the data is descrambled.

10. The method of claim 9 further including:
deinterleaving the data, wherein the data is deinterleaved before the data is decoded.

11. A receiver, the receiver being arranged to process data obtained from a multimode fiber, the receiver comprising:
means for obtaining the data from the multimode fiber;
means for decoding the data, wherein the means for decoding the data include means for applying a forward error correction decoding algorithm to the data;
means for descrambling the data after the data is decoded; and
means for deframing the data after the data is descrambled.

12. A method for operating an optical network, the optical network having a first element and a second element, the first element and the second element being in communication over a multimode fiber, the method comprising:
encoding the data at the first element, wherein encoding the data includes applying forward error correction encoding to the data;
transmitting the encoded data from the first element to the second element across the multimode fiber;
receiving the encoded data at the second element; and
decoding the encoded data at the second element, wherein decoding the encoded data includes applying forward error correction decoding to the encoded data.

13. The method of claim 12 further including:
interleaving the encoded data before transmitting the encoded data from the first element to the second element across the multimode fiber; and
deinterleaving the encoded data before decoding the encoded data at the second element.
